(19) United States
(12) Patent Application Publication
(10) Pub. No.: US 2024/0249871 A1
(43) Pub. Date: Jul. 25, 2024

(54) WIRE-WOUND INDUCTOR USING MAGNETIC CORES WITH THREE AIR GAPS

(71) Applicant: ACME Electronics Corporation, Taipei City (TW)

(72) Inventors: Jiu Nan LIN, Taipei City (TW); Tzu To CHU, Taipei City (TW); Chih Ho WU, Taipei City (TW); Chen-Chih LEE, Taipei City (TW)

(21) Appl. No.: 18/296,639

(22) Filed: Apr. 6, 2023

(30) Foreign Application Priority Data
Jan. 19, 2023 (TW) 112102622

(51) Int. Cl. H01F 27/24; H01F 27/28

(52) U.S. Cl. CPC H01F 27/24; H01F 27/2823

(57) ABSTRACT

A wire-wound inductor using magnetic cores with three air gaps, which comprises a magnetic housing cores, an inner magnetic cores, and coils, characterized in that: multiple size combination of inner magnetic cores can be accepted in the magnetic housing cores with the same size; the magnetic housing cores and the inner magnetic cores can be made of different magnetic materials; the size and the material of the two magnetic parts of the inductor can be selected to meet the requirement of application frequency and power. The inductor adopts the magnetic cores with the air gaps in the mating areas between the magnetic housing core and the inner magnetic core as well as the two inner magnetic cores to form three air gaps. The types of the magnetic cores of the inductors are categorized as PM, RM and PQ by IEC standard. The inductors perform larger saturation current, higher inductance value and lower core loss. Furthermore, the good heat dissipation of the coils due to the selected housing core geometry is concerned so as to improve the life cycle of the inductor.

### BACKGROUND OF THE INVENTION

### 1. Technical Field

The present invention relates to a wire-wound inductor using magnetic cores with three air gaps. More particularly, the invention relates to a wire-wound inductor that uses magnetic cores of a PQ, PM, or RM configuration, and the magnetic cores include three air gaps.

### 2. Description of Related Art

Wire-wound inductors are passive devices that are in extensive use in electronic products, and whose working principle involves changing the current in a coil to generate a change in magnetic flux. One conventional type of materials of which wire-wound inductors are made is ferrites, whose level of magnetic saturation, however, is relatively low, and in order for a voltage step-up or step-down device or power factor correction (PFC) inductor made of a ferrite to have a higher level of magnetic saturation, it has been common practice to form an air gap in such a device. A conventional wire-wound inductor essentially includes a coil former and a magnetic core, as shown in the published drawings of Taiwan Utility Model Patent No. M264631, titled “Improved Structure of Magnetic Core of Inductor” (see FIG. 1(a)), and in the published drawings of Taiwan Utility Model Patent No. M264632, titled “Improved Structures of Magnetic Core and Coil Former of Inductor” (see FIG. 1(b)). The inductors disclosed in both patents cited above include magnetic cores 100A(100B) and a coil former 200A(200B). Each magnetic core 100A/100B includes a center post 110A(110B), and on each of the two lateral sides of the center post 110A(110B) is an outer leg 111A(111B) that extends toward the other magnetic core 100A(100B). The coil former 200A(200B) is centrally provided with a central hole 220A(220B), and a coil 222A(222B) is wound on and around the outer periphery of the central hole 220A(220B). To put the magnetic cores 100A(100B) and the coil former 200A(200B) together, the center posts 110A(110B) of the two magnetic cores 100A(100B) are inserted into the central hole 220A(220B) of the coil former 200A(200B) from two opposite ends of the coil former 200A(200B) respectively until the outer legs 111A/111B cover two opposite lateral sides of the coil former 200A(200B) respectively.

Each magnetic core 100A(100B) is integrally formed, so the shape and volume of the center posts 110A(110B) cannot be changed after the magnetic cores 100A(100B) are formed by pressing in their respective molds. Moreover, the center posts 110A(110B) and the outer legs 111A(111B) are made of the same material, so the degree of freedom in the choice of material is subject to limitations. Now that the manufacture of inductors of different powers calls for magnetic cores of different sizes and materials, the numerous combinations of magnetic cores will require a huge number of molds, meaning a magnetic powder core manufacturer cannot meet market demand without making a considerable investment.

To solve the problems stated above, Taiwan Utility Model Patent No. M427657 (see FIG. 2(a)) provides a structural design in which two air gaps are used instead of one. As shown in FIG. 2(a), the design model of the '657 patent forms an air gap between each of two opposite ends 21C of the post 110C and the inner bottom side 111C of the corresponding half of the housing 100C. The inventor of the '657 patent mentions that the design model has such advantages as ease of heat dissipation from the inductor and a long service life of the inductor. However, as the post-shaped magnetic core in this patent is integrally formed and has a high manufacturing tolerance in height, not only is product assembly made difficult, but also the finished magnetic core has a high inductance tolerance; that is to say, high-precision products (e.g., within ±5% of the design specifications) are hard to obtain. Chinese Utility Model Patent No. CN209515404U (see FIG. 2(b)) discloses a prior art in which at least two rod cores (or R cores) 110D are used. The rod cores 110D are coaxially provided between the short center posts 80D of the two halves of the PQ magnetic core housing 100D, with an air space formed between two adjacent ones of the rod cores 110D, an insulating pad 4D adhesively boned between the corresponding ends of each remaining pair of adjacent rod cores 110D, and an insulating pad 4D adhesively bonded between each rod core 110D adjacent to the short center post 80D of one of the two halves of the PQ magnetic core housing 100D and this short center post 80D. The inventor of this patent mentions that the foregoing design (whose structural diagram is shown in FIG. 2(b)) has such advantages as great ability in energy storage and low proneness to saturation. However, as the two outermost air gaps are each located between the short center post 80D of one of the two halves of the PQ magnetic core housing 100D and the adjacent rod core 110D, the relatively low saturation current caused by the relatively small cross-sectional areas of the magnetic path corners at the junctions between the bottom portion of each of the two halves of the PQ magnetic core housing 100D and the corresponding short center post 80D remains a problem to be solved.

Besides, the product of the winding window area of an inductor and the cross-sectional area of the magnetic core of the inductor (i.e., WaAc) is correlated to the power-handling ability of the magnetic core. The greater the product, the higher the power that can be handled. As the conventional inductor structures typically use integrally formed magnetic cores, the specifications of the molds used to make the cores limit not only the shapes and volumes of the core posts, but also the sizes of the coil formers (and hence the winding window areas). This is why the conventional inductors are suitable for use only in specific power supply products whose powers are within a limited range.

FIG. 3 shows a conventional inductor in the assembled state. In this inductor structure, an air gap 300E is formed between the two magnetic core posts 110E (i.e., between the upper and lower magnetic cores 100E). The air gap 300E corresponds to a portion of the coil wound around the magnetic core posts 110E. When this inductor is in use, a relatively high current tends to be generated in the coil portion corresponding to the air gap 300E, and the inductor will generate heat as a result. Moreover, the air gap 300E, which is located at the center of the magnetic core posts 110E, will cause magnetic fringing flux such that the current density in the surrounded conductor wires of the coil is more concentrated in one place than in another, resulting in an inevitable increase in wire temperature and thus shortening the service life of the inductor. To address the heat dissipation issue, the PQ, RM, and PM core shapes were invented as specified in the IEC 63093 standards, the objective being to accelerate heat dissipation from a device using a ferrite core. In those three core designs, however, magnetic saturation tends to occur in the magnetic path corners in the middle of the magnetic core base due to the relatively small cross-sectional areas of the corners; in other words, a device using a PQ/RM/PM core may have a relatively low saturation current. It can be known from the foregoing analysis that the existing products fail to address the issues of heat dissipation and high-current applications at the same time.

The primary objective of the present invention is to solve the aforesaid problems of the prior art.

### BRIEF SUMMARY OF THE INVENTION

An inductor was made according to the designs in FIG. 1(a) and FIG. 1(b), and simulation software FEMM 4.2 was used to simulate the magnetic flux distribution in a longitudinal section of the inductor during use. As can be seen in the partial enlarged view of the simulation result in FIG. 4, the magnetic field expands outward, so called fringing flux, (as indicated by the magnetic lines M1 and M2) around the central air gap in the assembled inductor. The phenomenon of magnetic fringing flux tends to increase the power loss of the magnetic cores and the temperature rise of the inductor. One conventional solution to the problem of temperature rise is to use the PQ/PM/RM structure specified in the IEC 63093 standards. Another conventional solution is to design an air gap at the junction between each of two opposing inner bottom sides of the two halves of the magnetic core housing and the corresponding core post, but the integrally formed core posts have a dimensional tolerance that not only causes difficulty in assembly, but also makes it impossible to make inductors whose inductance tolerance is required to be within ±5%. Furthermore, a magnetic core of a PQ/PM/RM configuration may have a relatively low saturation current because partial magnetic saturation tends to take place in the magnetic path corners at the base of the magnetic core post due to the relatively small cross-sectional areas of the corners.

Aiming to solve such problems as the relatively low saturation current of an inductor using a PQ/PM/RM core and the relatively high inductance tolerance of the existing inductors, the present invention provides a wire-wound inductor using a PQ/RM/PM core with three air gaps. This wire-wound inductor is characterized in that the posts of the two (i.e., upper and lower) magnetic cores are independently formed, and that the remaining portions of the magnetic cores form an independent housing. By adjusting or changing the sizes and materials of the posts and the housing and the distance between the two posts, the inductor of the invention can be adapted for use in products of different powers.

The wire-wound inductor of the present invention allows its magnetic cores to be replaced, and this increases the degree of freedom in the dimensional combinations of the housing and the posts. For example, the winding window area can be changed by changing the dimensions of the posts, or a fixed-sized housing can be used with various dimensional combinations of the posts. The degree of freedom of choosing the materials of the housing and the posts is also increased. More specifically, the materials of the housing and the posts can be chosen according to requirements in connection with the properties of magnetic materials, the operating frequency, and so on, and the housing and the posts may be made of different materials respectively. The replaceable magnetic cores not only allow a user who has completed a circuit design to choose a suitable dimensional combination based on such factors as the power required, a predetermined cost, an allowable loss, and the installation space, but also help increase manufacturing precision, and this is one of the objectives of the invention.

The three-air-gap wire-wound inductor of the present invention is composed of two magnetic members each having an independently formed post. As the posts are independently formed, the inductor of the invention has an air gap between the bottom plate of each half of the housing and the adjacent end face of the corresponding post, i.e., at each of two opposite ends of the coil former, and an air gap at the center of the assembled inductor. The air gaps in the inductor of the invention provide efficient heat dissipation and therefore contribute to extending the service life of the inductor, and this is the second objective of the invention.

The three-air-gap wire-wound inductor of the present invention has a low power loss, a high saturation current, and a high inductance value because of the multiple air gaps, and this is the third objective of the invention.

For the above purpose, the present invention discloses a wire-wound inductor using magnetic cores with three air gaps, comprising a magnetic housing, two magnetic posts provided at central portions of two opposing inner sides of the magnetic housing respectively, an isolation unit provided in the magnetic housing and enclosing the magnetic posts, and a coil provided on the isolation unit, wherein a non-magnetic insulating member is provided between one of the two opposing inner sides of the magnetic housing and a corresponding said magnetic post to form a first air gap, another non-magnetic insulating member is provided between the other of the two opposing inner sides of the magnetic housing and a corresponding said magnetic post to form a second air gap, and a third air gap is formed between the two magnetic posts.

Further, the two opposing inner sides of the magnetic housing are flat surfaces.

Further, the magnetic housing and the magnetic posts form an assembly of a PM configuration, a PQ configuration, or an RM configuration.

Further, the magnetic housing is made of a ferrite selected from the group consisting of a manganese-zinc ferrite, a nickel-zinc ferrite, and a magnesium-zinc ferrite, and the magnetic posts are made of a ferrite or a magnetic alloy.

Further, the magnetic posts are made of a manganese-zinc ferrite, a nickel-zinc ferrite, a magnesium-zinc ferrite, an iron-silicon alloy, an iron-nickel alloy, an iron-silicon-aluminum alloy, a nickel-iron-molybdenum alloy, an amorphous alloy, or a nanocrystalline alloy.

Further, the non-magnetic insulating members are made of an insulating material selected from the group consisting of an FR-4 material and a polyester film.

Further, the first air gap and the second air gap are defined by a same distance.

Further, the wire-wound inductor has an inductance tolerance controllable within ±5% by adjusting a distance defining the first air gap, the second air gap, or the third air gap.

Further, the non-magnetic insulating members are sized according to materials of the magnetic housing and of the magnetic posts of the wire-wound inductor.

Further, the first air gap, the second air gap, and the third air gap are respectively defined by shorter distances when the magnetic posts are made of a magnetic alloy than when the magnetic posts are made of a ferrite.

According to the above, the three-air-gap wire-wound magnetic core assembly of the present invention advantageously features a high inductance value, a high saturation current, a low power loss, a low temperature rise, and a long service life.

### BRIEF DESCRIPTION OF THE SEVERAL VIEWS OF THE DRAWINGS

FIG. 1 shows exploded perspective views of two prior art inductors.

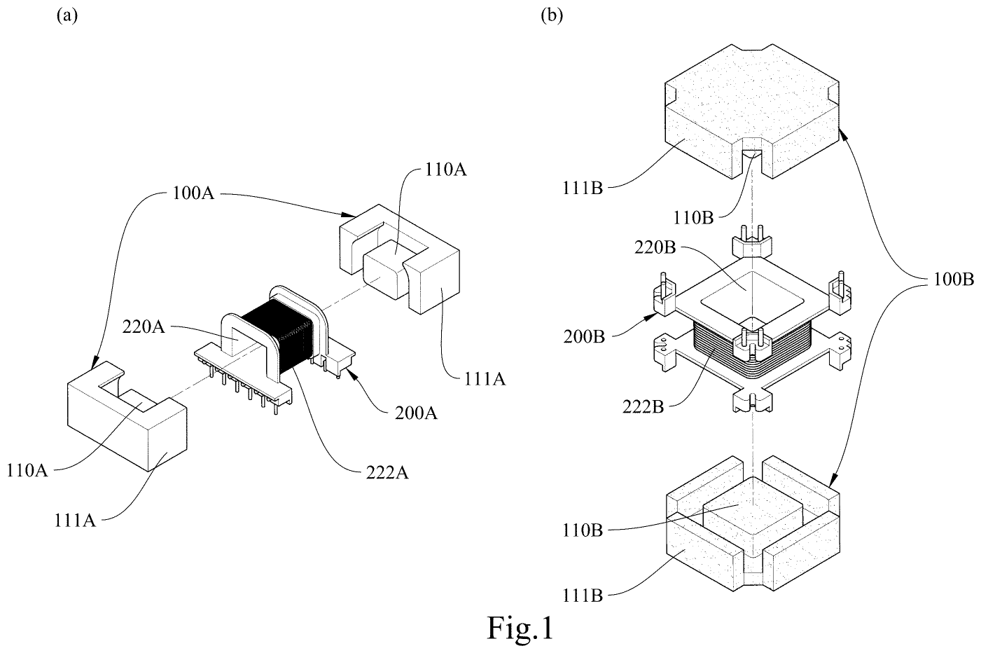

FIG. 2 shows sectional views of another two prior art inductors.

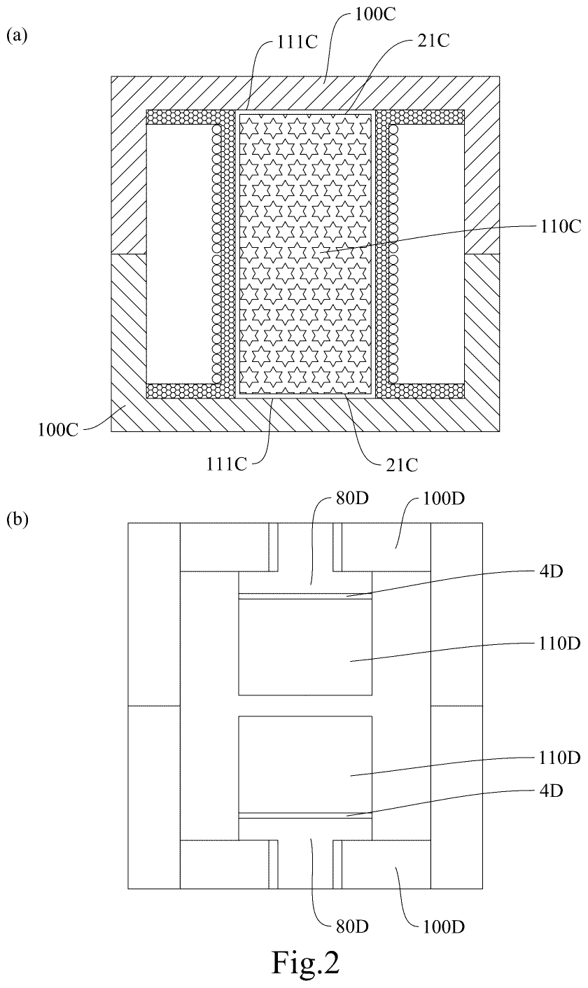

FIG. 3 is a sectional view of yet another prior art inductor.

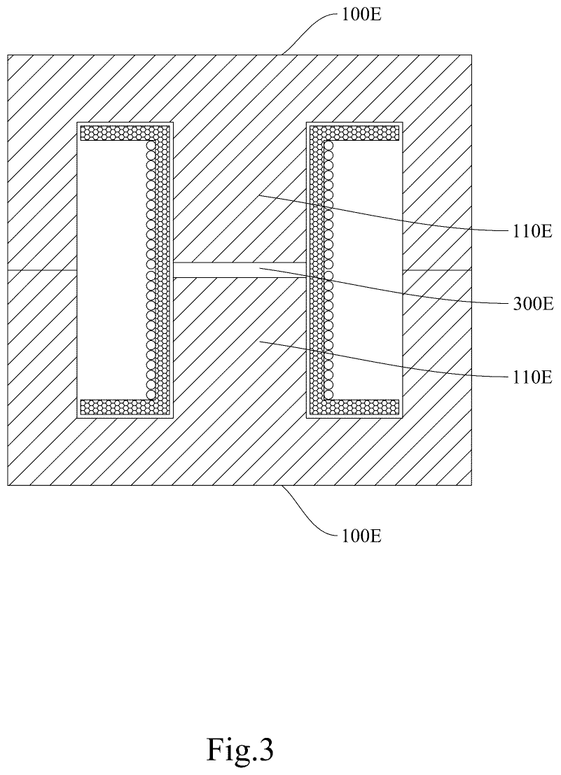

FIG. 4 shows the magnetic flux distribution in a longitudinal section of the prior art inductors in FIG. 1.

FIG. 5 is a perspective view of a wire-wound inductor of the present invention, wherein the inductor uses magnetic cores with three air gaps.

FIG. 6 is an exploded perspective view of the wire-wound inductor in FIG. 5.

FIG. 7 is a sectional view of the wire-wound inductor in FIG. 5.

FIG. 8 is a sectional view of a wire-wound inductor of the present invention and shows an FEMM 4.2 simulation of the magnetic field intensity distribution in the inductor, wherein the inductor uses PQ magnetic cores.

FIG. 9 is an inductance vs saturation current plot, showing a comparison between a three-air-gap wire-wound inductor of the present invention and a conventional magnetic core assembly with a single air gap in the core post.

### DETAILED DESCRIPTION OF THE INVENTION

The detailed description and technical contents of the present invention are described below with respect to the drawings. Furthermore, the drawings in the present invention may not be drawn to the actual scale for the convenience of illustration, but may be exaggerated, and such drawings and their scale are not intended to limit the scope of the present invention.

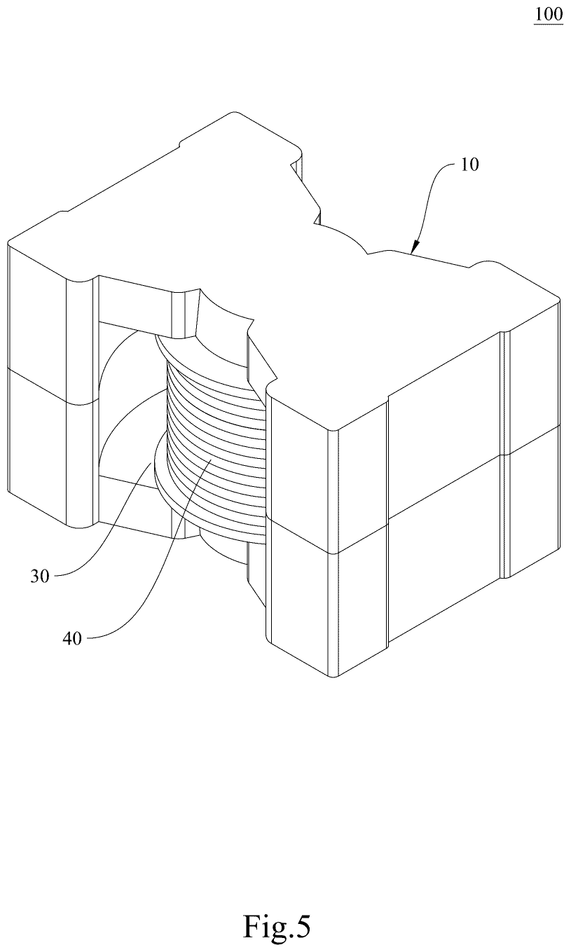

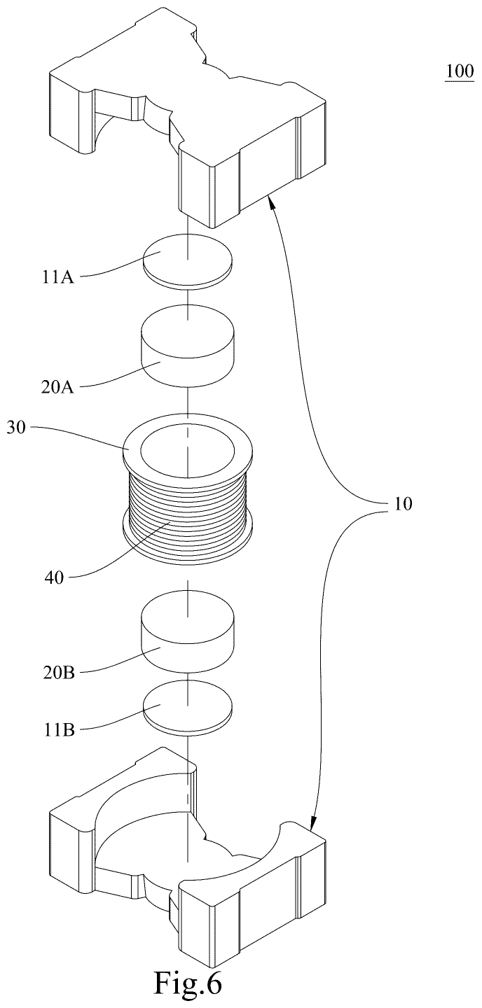

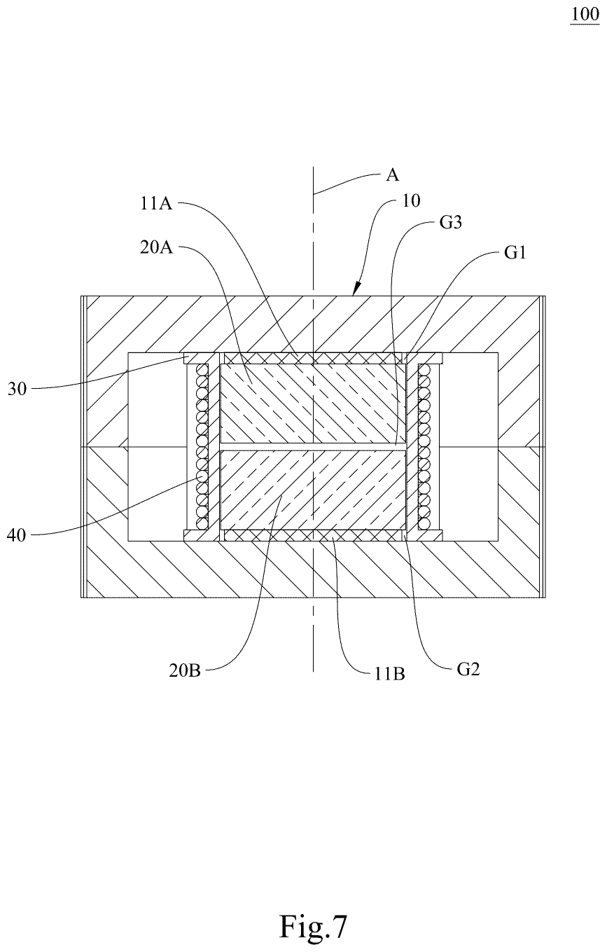

The present invention provides a structural design concept for a three-air-gap wire-wound inductor. An embodiment of the concept is described below with reference to FIG. 5, FIG. 6, and FIG. 7, which are respectively an assembled perspective view, an exploded perspective view, and a sectional view of a wire-wound inductor using magnetic cores with three air gaps.

This embodiment discloses a wire-wound inductor 100 using magnetic cores with three air gaps. The wire-wound inductor 100 essentially includes a magnetic housing 10, two magnetic posts 20A and 20B, an isolation unit 30, and a coil 40. The magnetic housing 10 encloses the other components and has an internal receiving space. In one embodiment, the magnetic housing 10 is divided into multiple components. For example, the magnetic housing 10 is divided in half, and the two halves are fixed together by an assembly method to form the assembled magnetic housing 10. Dividing the magnetic housing 10 into multiple components facilitates assembly of the wire-wound inductor 100.

The magnetic posts 20A and 20B are provided at the centers of two opposing inner sides of the magnetic housing 10 respectively. The two opposing inner sides of the magnetic housing 10 on which the magnetic posts 20A and 20B are respectively provided are flat surfaces, which allow the wire-wound inductor 100 of the present invention to have a high inductance value Ls, a high saturation current value Is, and a low power loss Pcv. More specifically, the magnetic posts 20A and 20B are provided in the receiving space of the magnetic housing 10, with the magnetic post 20A provided on the inner wall surface of one side of the magnetic housing 10, and the magnetic post 20B on the inner wall surface of the opposite side of the magnetic housing 10. The magnetic post 20A and the magnetic post 20B are aligned with each other such that the axes of the two magnetic posts 20A and 20B coincide (as indicated by the axis A in FIG. 7). A non-magnetic insulating member 11A is provided between the central portion of one of the two opposing inner sides of the magnetic housing 10 and the magnetic post 20A to form a first air gap G1, and a non-magnetic insulating member 11B is provided between the central portion of the other of the two opposing inner sides of the magnetic housing 10 to form a second air gap G2. In addition, the magnetic housing 10 and the magnetic posts 20A and 20B are so sized that once the magnetic posts 20A and 20B are mounted in the magnetic housing 10, a third air gap G3 is formed between the two magnetic posts 20A and 20B. In one embodiment, the first air gap G1 and the second air gap G2 are of the same size, and the third air gap G3 can be adjusted according to the required saturation current value and inductance value of the product. In one embodiment, the non-magnetic insulating members 11A and 11B are made of an insulating material such as an FR-4 material or a polyester film (e.g., a Mylar polyethylene terephthalate (PET) film); the invention has no limitation in this regard. In one embodiment, the third air gap G3 is composed of air, but the invention has no limitation in this regard either.

The isolation unit 30 is provided in the magnetic housing 10 and encloses the magnetic posts 20A and 20B. The coil 40 is provided on the isolation unit 30. The isolation unit 30 is used to isolate the coil 40 from the magnetic posts 20A and 20B, lest a short circuit be formed between the coil 40 and the magnetic posts 20A and 20B. In one embodiment, the isolation unit 30 is, for example but not limited to, a coil former on which the coil 40 is wound and includes a through hole into which the magnetic posts 20A and 20B can be put. In another embodiment, the isolation unit 30 is insulating paper, insulating adhesive, or other similar mechanism attached to the inner side of the coil 40 to isolate the coil 40 from the magnetic posts 20A and 20B placed in the center of the coil 40. The configuration of the isolation unit 30 does not constitute an essential feature of the present invention and therefore may vary as in the foregoing embodiments.

In one embodiment, the first air gap G1 and the second air gap G2 (which are formed between the magnetic posts 20A and 20B and the magnetic housing 10) and the third air gap G3 (which is formed between the magnetic posts 20A and 20B) are respectively defined as distances ranging from 0.28 mm to 0.4 mm. More specifically, the distances may be, but are not limited to, 0.28 mm, 0.29 mm, 0.30 mm, 0.31 mm, 0.32 mm, 0.33 mm, 0.34 mm, 0.35 mm, 0.36 mm, 0.37 mm, 0.38 mm, 0.39 mm, or 0.4 mm; the present invention has no limitation in this regard. By controlling the sizes of the three air gaps, a desirable inductance value Ls, saturation current value Is, and power loss Pcv can be obtained.

In one embodiment, the assembly of the magnetic housing 10 and the magnetic posts 20A and 20B has a PM configuration, a PQ configuration, or an RM configuration. In one embodiment, the material of the magnetic housing 10 is a ferrite, such as but not limited to a manganese-zinc ferrite (a manganese-zinc material), a nickel-zinc ferrite (a nickel-zinc material), or a magnesium-zinc ferrite (a magnesium-zinc material); the present invention has no limitation in this regard. In one embodiment, the material of the magnetic posts 20A and 20B is a ferrite or a magnetic alloy, wherein the ferrite may be, for example but not limited to, a manganese-zinc ferrite (a manganese-zinc material), a nickel-zinc ferrite (a nickel-zinc material), or a magnesium-zinc ferrite (a magnesium-zinc material), and wherein the magnetic alloy may be, for example but not limited to, an iron-silicon alloy, an iron-nickel alloy, an iron-silicon-aluminum alloy, a nickel-iron-molybdenum alloy, an amorphous alloy, or a nanocrystalline alloy. The materials of the magnetic housing 10 and of the magnetic posts 20A and 20B can be chosen according to requirements in connection with the operating frequency, power, and so on. Moreover, the magnetic housing 10 and the magnetic posts 20A and 20B may be made of different materials respectively. For example, the magnetic housing 10 is a manganese-zinc material while the magnetic posts 20A and 20B are an iron-silicon-aluminum alloy. The magnetic housing 10 and the magnetic posts 20A and 20B may also be made of the same ferrite or of different ferrites respectively; the invention has no limitation in this regard.

In one embodiment, the first air gap G1 and the second air gap G2 are defined by the same distance due to manufacturing considerations. By controlling the sizes of the air gaps (i.e., by adjusting the distance defining each of the first air gap G1, the second air gap G2, and the third air gap G3) with precision, the inductance tolerance of the wire-wound inductor 100 in this embodiment can be controlled within ±5%. In one embodiment, the distance defining each of the first air gap G1, the second air gap G2, and the third air gap G3 is smaller when the magnetic posts 20A and 20B are made of a magnetic alloy than when the magnetic posts 20A and 20B are made of a ferrite, and the wire-wound inductor 100 has a higher inductance value Ls, a higher saturation current value Is, and a lower power loss Pcv when the magnetic posts 20A and 20B are made of a magnetic alloy than when the magnetic posts 20A and 20B are made of a ferrite. In one embodiment, the sizes of the non-magnetic insulating members 11A and 11B depend on the materials of the magnetic housing 10 and of the magnetic posts 20A and 20B of the wire-wound inductor 100.

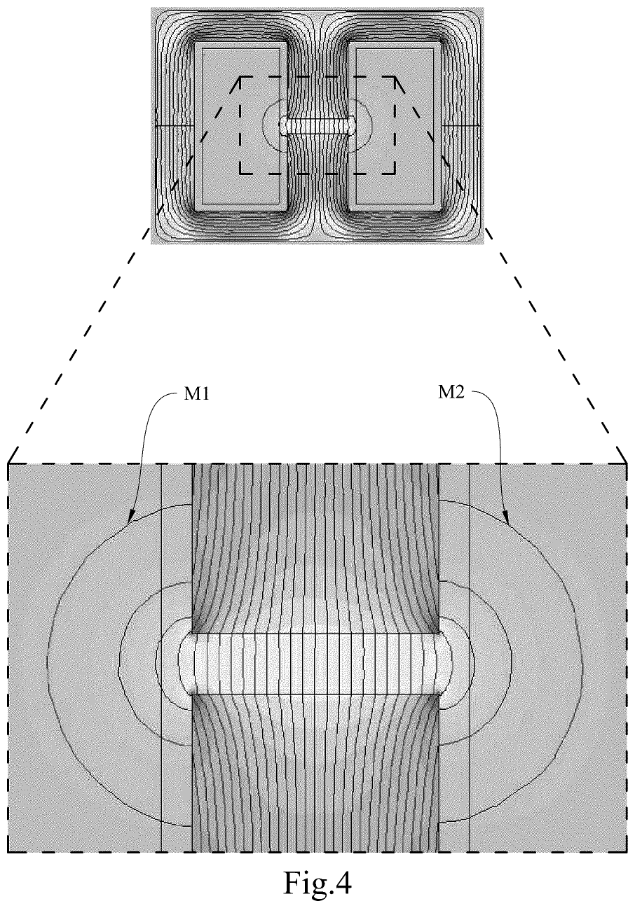

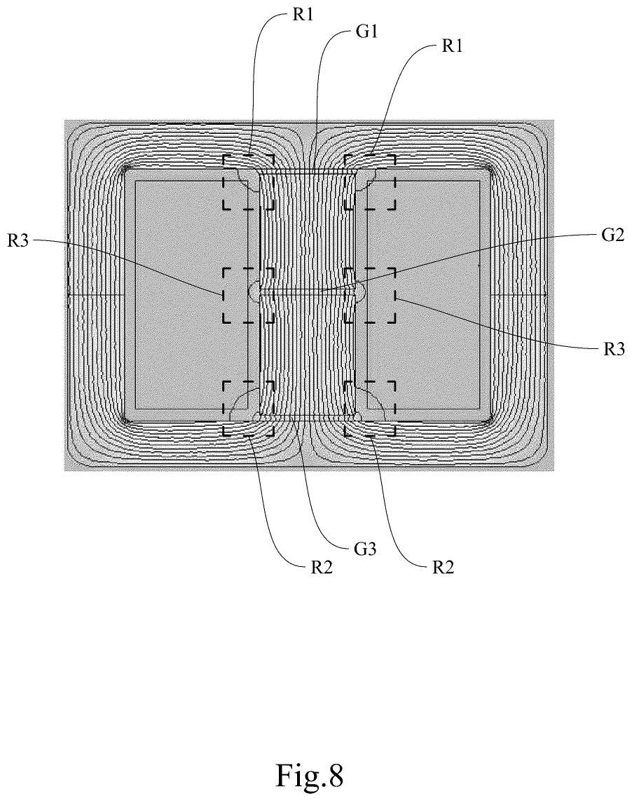

FIG. 8 is a sectional view of a wire-wound inductor of the present invention that uses PQ magnetic cores. FIG. 8 also shows an FEMM 4.2 simulation of the magnetic field intensity distribution in this wire-wound inductor. As the magnetic core assembly of the invention (i.e., the assembly of the magnetic posts 20A and 20B and the magnetic housing 10) has three air gaps (i.e., the air gap G1, the air gap G2, and the air gap G3), magnetic leakage at the air gaps (e.g., in the areas R1, R2, and R3) is lower than that of a magnetic core assembly with a single air gap (see FIG. 4 for the FEMM 4.2 simulation of the magnetic field intensity distribution in a single-air-gap magnetic core assembly). It can therefore be inferred that the magnetic core design of the invention contributes to a lower power loss and a lower temperature rise than those of a single-air-gap magnetic core assembly, and allows a product using the magnetic core design to have a higher current strength than a product using a single-air-gap magnetic core assembly.

The wire-wound inductor using magnetic cores with three air gaps as disclosed herein is manufactured as follows. To begin with, suitable material formula systems are chosen for the magnetic housing 10 and the magnetic posts 20A and 30A respectively. The magnetic housing 10 may be made of a ferrite such as a manganese-zinc material, a nickel-zinc material, or a magnesium-zinc material. The magnetic posts 20A and 20B may be made of a ferrite such as a manganese-zinc material, a nickel-zinc material, or a magnesium-zinc material, or be made of an alloy such as an iron-silicon alloy, an iron-silicon-aluminum alloy, an iron-nickel alloy, an iron-nickel-molybdenum alloy, an amorphous alloy, or a nanocrystalline alloy. Suitable materials can be chosen according to requirements in connection with the operating frequency, power, and so on. The magnetic housing 10 and the magnetic posts 20A and 20B may be made of different materials respectively. For example, the magnetic housing 10 is made of a manganese-zinc material while the magnetic posts 20A and 20B are made of an iron-silicon-aluminum alloy. It is also feasible to make the magnetic housing 10 and the magnetic posts 20A and 20B out of the same ferrite or out of different ferrites respectively.

The next step is to choose a non-magnetic insulating member 11A (e.g., an insulating material such as an FR-4 printed circuit board (PCB) material or a Mylar PET film) of a suitable thickness and bond the non-magnetic insulating member 11A adhesively (e.g., through an epoxy AB glue) to a central portion of the inner bottom side of one half of the completed magnetic housing 10 (which may have a PQ, PM, or RM configuration). Then, the sintered magnetic post 20A is adhesively bonded (e.g., through an epoxy AB glue) to the exposed side of the non-magnetic insulating member 11A to complete the half of the magnetic core assembly that has the first air gap G1.

The other half of the magnetic core assembly, i.e., the half with the second air gap G2, is made in the same way. More specifically, a non-magnetic insulating member 11B (e.g., an insulating material such as an FR-4 PCB material or a Mylar PET film) of a suitable thickness is chosen and adhesively bonded (e.g., through an epoxy AB glue) to a central portion of the inner bottom side of the other half the completed magnetic housing 10 (which may have a PQ, PM, or RM configuration). Then, the sintered magnetic post 20B is adhesively bonded (e.g., through an epoxy AB glue) to the exposed side of the non-magnetic insulating member 11B to complete the half of the magnetic core assembly that has the second air gap G2.

Following that, the magnetic posts 20A and 20B are ground to level their end faces and thereby control their heights, and then the two halves of the magnetic core assembly, i.e., the half with the first air gap G1 and the half with the second air gap G2, are put together along with the isolation unit 30 and the coil 40 to complete the wire-wound magnetic core assembly with the first air gap G1, the second air gap G2, and the third air gap G3, wherein the size of the third air gap G3 can be adjusted according to the desired inductance value, power loss, and saturation current value. It should be pointed out that there is no limitation on the dimensions of each independent part of the inductor 100 of the present invention. Suitable dimensional combinations can be chosen according to the electronic circuit with which the inductor 100 is to be used, in order to meet, among others, the desired inductance, a predetermined cost, an allowable range of loss, and the requirements of the installation space.

The wire-wound inductor 100 using magnetic cores with three air gaps as disclosed herein is so designed that its air gaps are respectively located at the junctions between the magnetic housing 10 and the magnetic posts 20A and 20B (i.e., at the non-magnetic insulating members 11A and 11B, which are insulating material such as an FR-4 PCB material or a Mylar PET film) and at the space between the two magnetic posts 20A and 20B. As an insulating material such as an FR-4 PCB material or a Mylar PET film is a mass-produced product whose thickness can be controlled, and the distance between the two magnetic posts 20A and 20B can be controlled with precision by grinding, the inductance value and saturation current value of the wire-wound magnetic core assembly of the invention can be precisely controlled, making it easy to manufacture products with a ±5% product precision.

The wire-wound inductor 100 using magnetic cores with three air gaps as disclosed herein has three air gaps (namely the first air gap G1, the second air gap G2, and the third air gap G3) in the magnetic cores, so the magnetic flux through the cross section of the inductor 100 leaks to a relatively low extent; that is to say, the current is relatively uniform, and the power loss of the inductor 100 is therefore relatively low. Given the same current, the wire-wound inductor 100 using magnetic cores with three air gaps as disclosed herein generates a relatively small amount of heat, and the heat can be easily dissipated thanks to the RM, PM, or PQ configuration of the magnetic core assembly. As a result, the service life of the inductor 100 is relatively long.

The inductor according to an embodiment of the present invention can be used as a PFC inductor, as a power choke, or in a power transformer; the invention has no limitation in this regard.

A detailed description of four different embodiments is given below.

### Embodiment 1

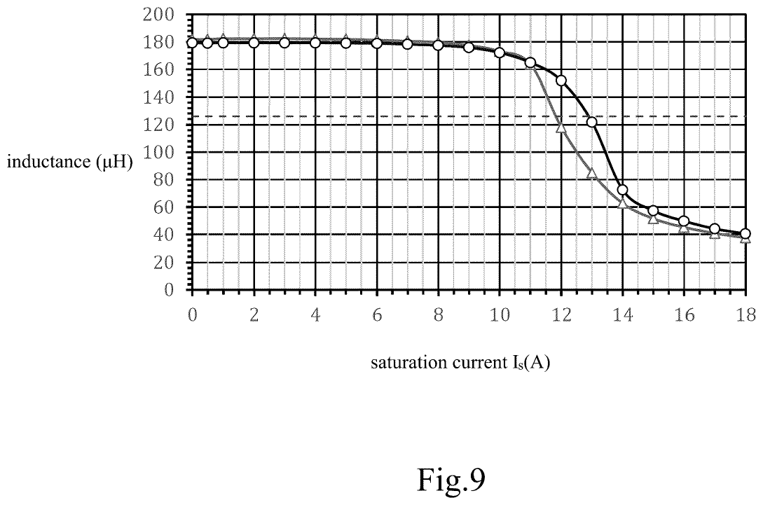

In this embodiment, a P451 manganese-zinc ferrite was made into a magnetic housing 10 of the PQ2620 configuration, and the same P451 material was used to make the magnetic posts 20A and 20B. The non-magnetic insulating members 11A and 11B serving respectively as the first air gap G1 and the second air gap G2 were Mylar PET films. The assembly process began by adhesively bonding a Mylar PET film having a thickness of 0.7 mm to one half of the PQ2620 magnetic housing 10 with an AB glue. Next, the P451 magnetic post 20A, which had a diameter of 12.1 mm, was adhesively bonded to the exposed side of the Mylar PET film with an AB glue. After the foregoing half of the magnetic core assembly was hardened by baking, the other half of the magnetic core assembly was made in the same way, i.e., by adhesively bonding another 0.7 mm-thick Mylar PET film to the other half of the PQ2620 magnetic housing 10 with an AB glue, then adhesively bonding the P451 magnetic post 20B, which had a diameter of 12.1 mm, to the exposed side of the latter Mylar PET film with an AB glue, and then hardening this half of the magnetic core assembly by baking. The magnetic posts 20A and 20B were subsequently ground to control the size of the third air gap G3 to be formed by putting the two halves of the magnetic core assembly together. After the magnetic core assembly was formed, with a coil of 40 turns wound around the isolation unit 30 surrounding the magnetic posts 20A and 20B, a three-air-gap wire-wound inductor 100 of the present invention was completed. The inductance value, saturation current value, and power loss Pcv of the completed inductor, or magnetic core assembly, 100 were then measured, and the results are shown in FIG. 9, which is a plot showing a comparison of inductance and saturation current between the three-air-gap wire-wound inductor 100 of the invention and a conventional magnetic core assembly with a single air gap in the core post. In FIG. 9, the triangular points are the test results, or measurements, of the conventional magnetic core assembly with a single air gap in the core post, and the circular points are the test results, or measurements, of the three-air-gap wire-wound magnetic core assembly 100. The conventional magnetic core assembly with a single air gap in the core post was such that the initial inductance specification of its 40-turn coil was 180 μH, and that its saturation current (defined as the biased current applied to the inductor resulting the inductance drop down to 70% of its initial inductance specification value) under the measuring conditions of 100 kHz and 50 mV was Is=11.78 A. To satisfy the 180 μH initial requirement, it was found through experiments that a suitable size of the third air gap G3 was 0.13 mm, and the saturation current of the wire-wound inductor 100 with such a third air gap G3 was Is=12.6 A, as shown in FIG. 9. In addition, the power loss of the wire-wound inductor 100 under the measuring conditions of 100 kHz and 50 mT was Pcv=53.5 mW/cm³, which is lower than the power loss (Pcv=86.7 mW/cm³) of the conventional magnetic core assembly with a single air gap in the core post. The foregoing results indicate that the three-air-gap wire-wound magnetic core assembly 100, whose magnetic housing 10 and magnetic posts 20A and 20B were made of the same material, had better electrical properties than the conventional magnetic core assembly with a single air gap in the core post.

### Embodiment 2

The same magnetic core materials as those in embodiment 1 were used, and the identical parts in embodiments 1 and 2 will not be described repeatedly. In this embodiment, the sizes of the first air gap G1, the second air gap G2, and the third air gap G3 were varied to produce wire-wound magnetic core assemblies with slightly different inductance values but within the range of 180 μH±5%. The test results of the electrical properties of those assemblies are shown in Table 1 below. It can be seen in the table that the three-air-gap wire-wound magnetic core assemblies had better electrical properties than the conventional magnetic core assembly with a single air gap in the core post. More specifically, given the same inductance specification, the three-air-gap wire-wound magnetic core assemblies had better inductance values Ls and power losses Pcv under the conditions of 50 kHz and 50 mT than the conventional magnetic core assembly with a single air gap in the core post. Furthermore, after considering both the inductance values Ls and the power losses Pcv under the conditions of 50 kHz and 50 mT, it was found that the three-air-gap wire-wound magnetic core assemblies had better properties when the first air gap G1 and the second air gap G2 ranged from 0.28 mm to 0.4 mm than when the first and the second air gaps G1 and G2 were otherwise sized.

TABLE 1
Sizes of the first air gaps G1, the second air gaps G2, and the
third air gaps G3; the saturation currents Is and inductance
values Ls of the magnetic core assemblies under test under the
conditions of 100 kHz and 100 mV; and the power losses Pcv of
the magnetic core assemblies under test under the conditions
of 50 kHz and 50 mT, with both the magnetic housings 10 and the
magnetic posts 20A and 20B made of a manganese-zinc material.

| | G1 | G2 | G3 | Is | Pcv | Ls |
|---|---|---|---|---|---|---|
| No. | (mm) | (mm) | (mm) | (A) | (mW/cm³) | (μH) |
| Comparative example 1 | 0 | 0 | 1.76 | 11.78 | 86.7 | 181.8 |
| Experiment 2 | 0.08 | 0.08 | 1.47 | 12.27 | 74.5 | 184.5 |
| Experiment 3 | 0.16 | 0.16 | 1.13 | 12.85 | 59.41 | 180.5 |
| Experiment 4 | 0.28 | 0.28 | 0.82 | 12.75 | 54.13 | 183.9 |
| Experiment 5 | 0.32 | 0.32 | 0.7 | 12.75 | 52.51 | 182.5 |
| Experiment 6 | 0.4 | 0.4 | 0.62 | 12.48 | 47.16 | 184.7 |
| Experiment 7 | 0.44 | 0.44 | 0.38 | 12.3 | 52.54 | 182.6 |
| Experiment 8 | 0.52 | 0.52 | 0.34 | 12.42 | 53.62 | 182.4 |
| Experiment 9 | 0.64 | 0.64 | 0.26 | 12.48 | 53.17 | 183.6 |

### Embodiment 3

In this embodiment, three-air-gap wire-wound inductors 100 were made in the same way as in embodiment 1. The magnetic housings 10 were still of the PQ2620 configuration and made of a manganese-zinc ferrite with the P451 material properties. The magnetic posts 20A and 20B, however, were nanocrystalline magnetic cores instead and had a diameter of 12.1 mm and a magnetic permeability of 60. As a comparative example, a wire-wound inductor having a magnetic core with two air gaps was made according to the design model of Taiwan Patent No. M427657. The test results are shown in Table 2. The tabulated results indicate that given the same saturation current value, the three-air-gap wire-wound inductors 100 had higher inductance values Ls under the conditions of 100 kHz and 50 mV and lower power losses Pcv under the conditions of 50 kHz and 50 mT than the conventional two-air-gap wire-wound magnetic core assembly, and that although the two-air-gap wire-wound magnetic core assembly had a higher saturation current value Is under the conditions of 100 kHz and 50 mV than the three-air-gap wire-wound inductors 100, it had a lower inductance value Ls and had a much higher power loss Pcv under the conditions of 50 kHz and 50 mT than the three-air-gap wire-wound inductors 100. Obviously, the three-air-gap wire-wound inductors 100 had the advantage of exhibiting better properties than the two-air-gap magnetic core assembly.

TABLE 2
Sizes of the first air gaps G1, the second air gaps G2, and the third
air gaps G3; the saturation currents Is and inductance values Ls
of the magnetic core assemblies under the conditions of 100 kHz
and 50 mV; and the power losses Pcv of the magnetic core assemblies
under test under the conditions of 50 kHz and 50 mT, with the magnetic
housings 10 made of a P451 manganese-zinc material, and the magnetic
posts 20A and 20B made of a nanocrystalline alloy.

| | G1 | G2 | G3 | Is | Pcv | Ls |
|---|---|---|---|---|---|---|
| No. | (mm) | (mm) | (mm) | (A) | (mW/cm³) | (μH) |
| Experiment 10 | 0.16 | 0.16 | 0.34 | 11.85 | 56.22 | 226.63 |
| Experiment 11 | 0.24 | 0.24 | 0.16 | 11.74 | 50.81 | 231.22 |
| Comparative | 0.55 | 0.55 | 0 | 14.35 | 76.09 | 177.38 |
| example 2 | | | | | | |

Accordingly, the present invention is disclosed above by way of preferred embodiments or examples, although it should be understood by those with ordinary knowledge in the art that such embodiments or examples are intended to describe the present invention only and should not be read as limiting the scope of the present invention. Furthermore, it should be noted that all variations and substitutions equivalent to such embodiments or examples shall be deemed to be covered by the scope of the present invention. Accordingly, the scope of protection of this invention shall be as defined in the following claims.

In summary, the wire-wound inductor using magnetic cores with three air gaps has the advantages of high inductance value, high saturation current, low power loss, low temperature rise, and long service life of the inductor.

The above has been explained in detail, but the above is only one of the better implementation examples of the invention, which should not be used to limit the scope of the implementation of the invention; that is, all the changes and modifications made according to the scope of the patent application of the invention should still fall within the scope of the patent of the invention.

What is claimed is:

1. A wire-wound inductor using magnetic cores with three air gaps, comprising: a magnetic housing, two magnetic posts provided at central portions of two opposing inner sides of the magnetic housing respectively, an isolation unit provided in the magnetic housing and enclosing the magnetic posts, and a coil provided on the isolation unit, wherein a non-magnetic insulating member is provided between one of the two opposing inner sides of the magnetic housing and a corresponding said magnetic post to form a first air gap, another non-magnetic insulating member is provided between the other of the two opposing inner sides of the magnetic housing and a corresponding said magnetic post to form a second air gap, and a third air gap is formed between the two magnetic posts.

2. The wire-wound inductor of claim 1, wherein the two opposing inner sides of the magnetic housing are flat surfaces.

3. The wire-wound inductor of claim 1, wherein the magnetic housing and the magnetic posts form an assembly of a PM configuration, a PQ configuration, or an RM configuration.

4. The wire-wound inductor of claim 1, wherein the magnetic housing is made of a ferrite selected from the group consisting of a manganese-zinc ferrite, a nickel-zinc ferrite, and a magnesium-zinc ferrite, and the magnetic posts are made of a ferrite or a magnetic alloy.

5. The wire-wound inductor of claim 1, wherein magnetic posts are made of a manganese-zinc ferrite, a nickel-zinc ferrite, a magnesium-zinc ferrite, an iron-silicon alloy, an iron-nickel alloy, an iron-silicon-aluminum alloy, a nickel-iron-molybdenum alloy, an amorphous alloy, or a nanocrystalline alloy.

6. The wire-wound inductor of claim 1, wherein the non-magnetic insulating members are made of an insulating material selected from the group consisting of an FR-4 material and a polyester film.

7. The wire-wound inductor of claim 1, wherein the first air gap and the second air gap are defined by a same distance.

8. The wire-wound inductor of claim 1, wherein the wire-wound inductor has an inductance tolerance controllable within ±5% by adjusting a distance defining the first air gap, the second air gap, or the third air gap.

9. The wire-wound inductor of claim 1, wherein the non-magnetic insulating members are sized according to materials of the magnetic housing and of the magnetic posts of the wire-wound inductor.

10. The wire-wound inductor of claim 1, wherein the first air gap, the second air gap, and the third air gap are respectively defined by shorter distances when the magnetic posts are made of a magnetic alloy than when the magnetic posts are made of a ferrite.
